(19) United States
(12) Patent Application Publication
(10) Pub. No.: US 2002/0010032 A1
(43) Pub. Date: Jan. 24, 2002

(54) System and method for bowling remotely

(76) Inventor: R. Dean Stiteler, Camp Hill, PA (US)

Correspondence Address: R. DEAN STITELER, 3804 LAMP POST LANE, CAMP HILL, PA, 17011, US

(21) Appl. No.: 09/905,656

(22) Filed: Jul. 16, 2001

Related U.S. Application Data
(60) Provisional application No. 60/199,849, filed on Apr. 26, 2000.

(51) Int. Cl. G06F 19/00

(52) U.S. Cl. 473/54; 463/40

(57) ABSTRACT

This invention relates generally to the playing of a bowling game by two or more persons not situated at the same physical location. In particular, to a system and method for two or more bowlers to engage in a bowling game at remote sites including a teleconferencing system that allows players located remotely from each other to see, hear, talk, interact and exchange data with each other, an automated bowling scoring system at each bowling site which scores the bowling game at each site at which the game is being played, and interface software transmitting, connecting and combining the bowling sites automated bowling scoring systems through the teleconferencing system. The bowling scoring systems have the capability, by use of the interface software through the teleconferencing system, to transmit the image of their site's bowler's frame-by-frame scorecard, to all remote sites, so that all bowlers can see all score cards on a continuous real-time interactive basis, in a combined, organized and coordinated manner, while they participate in the remote bowling game.

### CROSS-REFERENCE TO RELATED APPLICATION

Provision Patent #60/199,849, filed Apr. 26/00

### BACKGROUND

1. Field of Invention

This invention relates to a multimedia system with the functionality particular to bowling. More specifically, the invention is a teleconferencing device adapted for transmission of bowling specific video, audio, and data over a network, including real-time transmission of images of lanes, pins, bowlers, bowler lounge areas, and bowler score cards.

2. Description of Prior Art

Bowling is a recreational and a competitive sport activity, which generally requires the participating players to congregate to the same physical site in order to engage in a game against each other.

While a bowler from one site can engage in a bowling game with players at remote sites by each player bowling separately and individually, then comparing their scores through various mediums, for example the phone, mail or internet, the quality of this game experience is lessened by the inability to see, hear, talk and interact with each bowler both socially and competitively, during the actual bowling game, as they could if they were bowling together at the same bowling site. Various informal and formal systems and methods of this form of bowling are currently in use. For example, a typical Internet site which engages in this type of remote-site bowling activity can be found at http://faldo.atmos.uiuc.edu/FBL/fblfront.html, which is hosted by the “Fantasy Bowling League”. This is a virtual bowling league operating over the internet where league bowlers bowl at their local bowling centers then send their scores via email or through the Fantasy Bowling League's score report process. Weekly standings are then posted to the Internet and merchandise prizes are awarded at the end of the season.

Alternatively, various real games have been modeled electronically. The electronic versions suffer the disadvantage of losing the important physical characteristics that participants are used to. For example, a person playing an electronic version of monopoly cannot move the game pieces around the board, receive and payout money, roll the dice, or pick up and discard property deeds. Electronic bowling games do not allow the players to choose their ball, approach their lane, roll the ball down the lane, and watch the ball hit the bowling pins. Such electronic games can be played by players at remote sites, through the use of computer and teleconferencing systems, but the quality of the game playing experience is lessened by the inability to interact with the real physical objects associated with the game. Various electronic bowling games of this type are on the market and in use. For example, Tiger Electronics, Inc.'s hand-held “electronic bowling” video game apparatus with a built-in display allows you to interactively work it's keyboard which in turn moves bowling pins and bowling ball images on it's display. After the ball hits the pins as displayed, a score is automatically calculated in a similar manner as is done in a real, traditional bowling game. But, the participants can not enjoy, among other things, the interaction with the real physical objects associated with a traditional bowling game.

Various teleconferencing systems have been developed to allow persons at remote sites to communicate and interact in a realistic way. They can speak with each other, see each other, hear each other, and exchange data with each other. In the bowling example, the people at each bowling site can each have the physical game apparatus, and the teleconferencing system, available at their site, and physically manipulate the game objects as the game progresses, as they would if they were at the same physical site. However such arrangement precludes the automated frame-by-frame scoring and display of the bowlers' scorecards, in a combined, coordinated and fluid manner from local-site-to-remote-site. In addition, the teleconferencing systems do not provide for the means of remote-site bowling-specific instructions that organize the operational flow of a remote-site bowling game. An example of a state-of-the-art teleconferencing system with excellent software and apparatus that allows individuals at different physical sites to speak, hear, see, interact and exchange data with each other in an efficient manner is the “PictureTel” teleconferencing system. It's expansiveness can be reviewed at their web site, http://www.picturetel.com. But even this system, like all teleconferencing conferencing systems in use, do not include a system or method for the interfacing of multiple bowling sites automated frame-by-frame scoring systems and display of the bowlers' scorecards, in a combined, coordinated and fluid manner from local-site-to-remote-site.

Various automated bowling scoring systems have been developed to calculate, record and display on video monitors, on a frame-by-frame basis, the image of each bowler's scorecard in combination and coordination with their bowling partner's at that physical site. However, such arrangements do not include a system or method for the image transmission of the bowler's frame-by-frame scorecard from one bowling site to other remote bowling sites through a multimedia system in a manner which displays, at all bowling sites, the combined and coordinated bowling scores of all participating bowlers, as if the bowling was being done at one physical site. For instance, the Brunswick Bowling & Billiards Corporation's recent patented “Automatic Bowling Center System” (U.S Pat. No. #5,709,607 of Jan. 20, 1998), and systems similar to this, allow for all of the state-of-the-art bowling scoring concepts, but do not provide for those scoring systems to be interfaced from site-to-site and their scorecard images to be combined, coordinated and operating simultaneously as one scorecard.

Further, AT&T Corporation's “System for Playing Card Games Remotely” (U.S Pat. No. #5,397,133 of Mar. 14, 1995), addresses the need and ability to play card games with players at remote sites, but it does not include a system or method for bowling games to be played with bowlers at remote sites.

### SUMMARY OF THE INVENTION

In accordance with the present invention, a system and method for two or more bowlers to engage in a bowling game at remote sites including; a teleconferencing system that allows players located remotely from each other to see, hear, talk, interact and exchange data with each other; an automated bowling scoring system at each bowling site which scores the bowling game at each site at which the game is being played; and interface software transmitting, connecting and combining the automated bowling scoring systems through the teleconferencing system. The bowling scoring systems have the capability, by use of the interface software through the teleconferencing system, to transmit the image of their site's bowler's frame-by-frame scorecard, to all remote sites, so that all bowlers can see all score cards on a continuous real-time interactive basis, in a combined, coordinated and fluid manner, while they participate in the remote bowling game.

This invention will eliminate the distance-factor in determining whether two or more bowlers can bowl with each other. It will enhance the pleasure, leisure and competition of individuals by allowing them to directly bowl with distant friends, relatives, and acquaintances, without requiring them to be at the same physical location. Further, it will broaden the scope in which league bowlers can compete, by allowing them to directly compete without requiring the league bowlers to be physically together.

Although various teleconferencing systems have been developed to allow bowlers at remote sites to communicate and interact in a realistic way. The teleconferencing systems do not provide for display of the automated frame-by-frame bowl scorecard, as created by each site's bowling scoring system, in a combined, coordinated and fluid manner from bowling site to bowling site. Further, the teleconferencing systems do not provide for the means of remote-site bowling-specific instructions that organize the operational flow of a remote-site bowling game.

In addition, although various automated bowling scoring systems have been developed to calculate and record bowling scores, on a frame-by-frame basis, and display on a video monitor a scorecard image of each bowler's score in coordination and conjunction with their bowling partner's at that physical site, the bowling scoring systems do not provide for the image transmission of the bowler's frame-by-frame scorecard image from one bowling site to other remote bowling sites through a multimedia system in a manner which displays, at all bowling sites, the combined, coordinated, continuous, real-time bowling scorecards of all participating bowlers, as if the bowling was being done at one physical site.

### BRIEF DESCRIPTION OF THE DRAWINGS

The invention will be fully appreciated by consideration of the following detailed description, which should be read in light of the accompanying drawings in which;

FIG. 1 is an overall illustration of two, physically separate, bowling sites, A and B, with lane configurations arranged in accordance with the present invention's required equipment;

FIG. 2 is an overall illustration of two, physically separate, bowling site configurations and their standard system connectivity arranged in accordance with the present inventions enhanced system connectivity.

FIG. 3 is a flowchart illustrating the step-by-step operation of a remote-site bowling game in accordance with the present invention.

FIG. 3(a) is the present invention's interface software computer screen design that illustrates the bowling site's service desk operator instructions needed to activate a remote-site bowling game.

### REFERENCE NUMERALS IN DRAWINGS

101. Bowler at bowling center site A, lane A

102. Bowler at bowling center site B, lane B

103. Bowling site ceiling

103-A. Bowling site A

103-B. Bowling site B

104. Overhead monitor

104-A. Bowling site A

104-B. Bowling site B

105. Desk monitor

105-A. Bowling site A

105-B. Bowling site B

106. Desk console

106-A. Bowling site A

106-B. Bowling site B

107. Overhead monitor screen section displaying the bowling lane and pin area of the remote bowling site

107-A. Bowling site A

107-B. Bowling site B

108. Overhead monitor screen section displaying the bowling lane scorecard image of the present bowling site

108-A. Bowling site A

108-B. Bowling site B

109. Overhead monitor screen section displaying the bowling lane scorecard image of the remote bowling site

109-A. Bowling site A

109-B. Bowling site B

110. Desk monitor screen section displaying the bowling lane kiosk/desk/lounge area of the remote bowling site

110-A. Bowling site A

110-B. Bowling site B

111. Desk monitor screen section displaying the bowling lane scorecard image of the present bowling site

111-A. Bowling site A

111-B. Bowling site B

112. Desk monitor screen section displaying the bowling lane scorecard image of the remote bowling site

112-A. Bowling site A

112-B. Bowling site B

113. Camera which continually views the bowler's lane kiosk/desk/lounge area at the present site and transmits the image to the background area of the desk monitor at the remote site, 110

113-A. Bowling site A

113-B. Bowling site B

114. Camera which views the bowler's lane and pin area at the present site and continuously transmits the image to the background area of the overhead monitor at the remote site, 107

114-A. Bowling site A

114-B. Bowling site B

115. Speaker apparatus

115-A. Bowling site A

115-B. Bowling site B

116. Microphone apparatus

116-A. Bowling site A

116-B. Bowling site B

117. Optional wireless mobile headset with microphone and earphone apparatus

117-A. Bowling site A

117-B. Bowling site B

118. Bowling pins at end of bowling lane, which are used in the bowling game

118-A. Bowling site A

118-B. Bowling site B

119. Keyboard which operates bowler scoring system

119-A. Bowling site A

119-B. Bowling site B

201. Lane kiosk/desk/lounge area with monitor, 105, speaker, 115, microphone, 116, keyboard, 119, and wireless headset, 117 (one unit per lane)

201-A. Bowling site A

201-B. Bowling site B

202. Bowling center service desk servicing all center lanes

202-A. Bowling site A

202-B. Bowling site B

203. Bowling center automated management, scoring and operating system standard wiring connectivity

203-A. Bowling site A

203-B. Bowling site B

204. Enhanced communication/data lines which transmit and display the bowler, lane, lounge area, and scorecard image of the bowler at bowling site A, to the monitors at the bowling site B, and which transmits and displays the bowler, lane, lounge area, and scorecard image of the bowler at the bowling site B, to the monitors at bowling site A.

205. Service desk computer system.

205-A. Bowling site A

205-B. Bowling site B

206. Teleconferencing software housed within the service desk computer system

206-A. Bowling site A

206-B. Bowling site B

207. Remote-site interface software (RSI) housed within the service desk computer system

207-A. Bowling site A

207-B. Bowling site B

208. Bowling center automated management, operating and scoring system housed within the service desk computer system

208-A. Bowling site A

208-B. Bowling site B

301. The present site's bowling center “identification (ID) #” field

302. The remote site's bowling center “identification (ID) #” field

303. The present bowler's “three initials of his full name” field

304. The remote site bowler's “three initials of his fall name” field

305. The present bowler's assigned “lane #” field

306. “Host/guest bowler designation” fields

307. Instructions for the host and guest bowler's service desk operator to follow after they fill in the host/guest bowler designation field

308. Connect button

### DETAILED DESCRIPTION

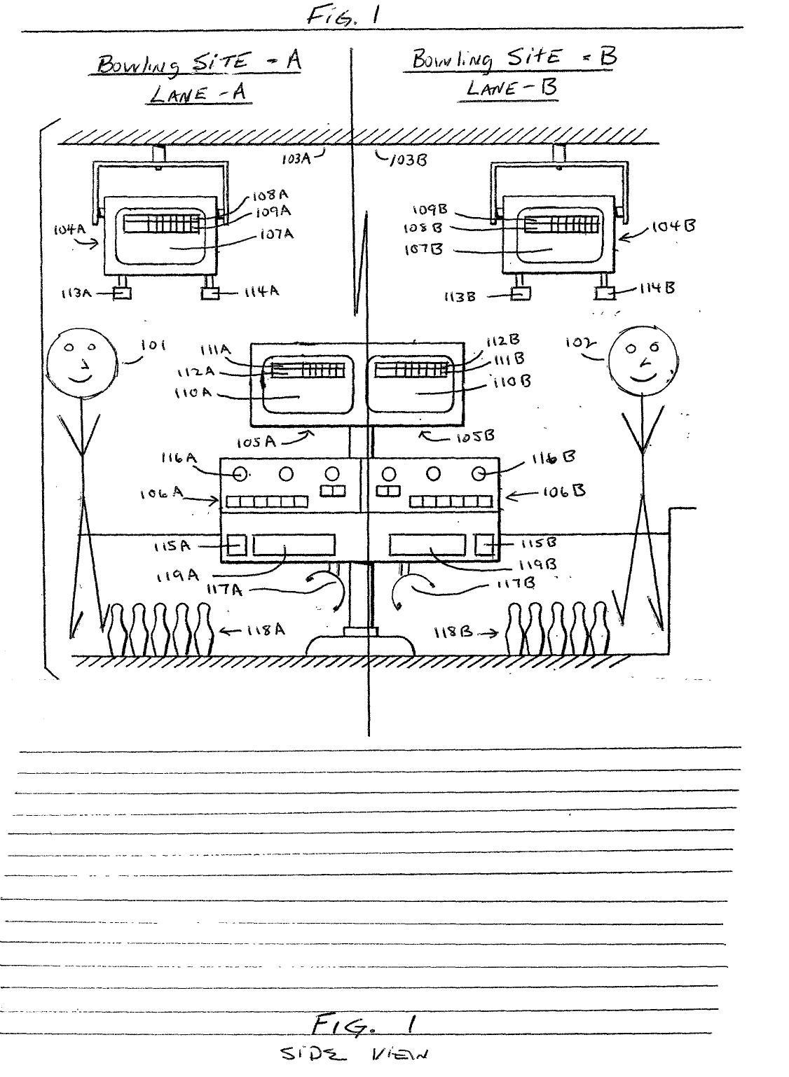

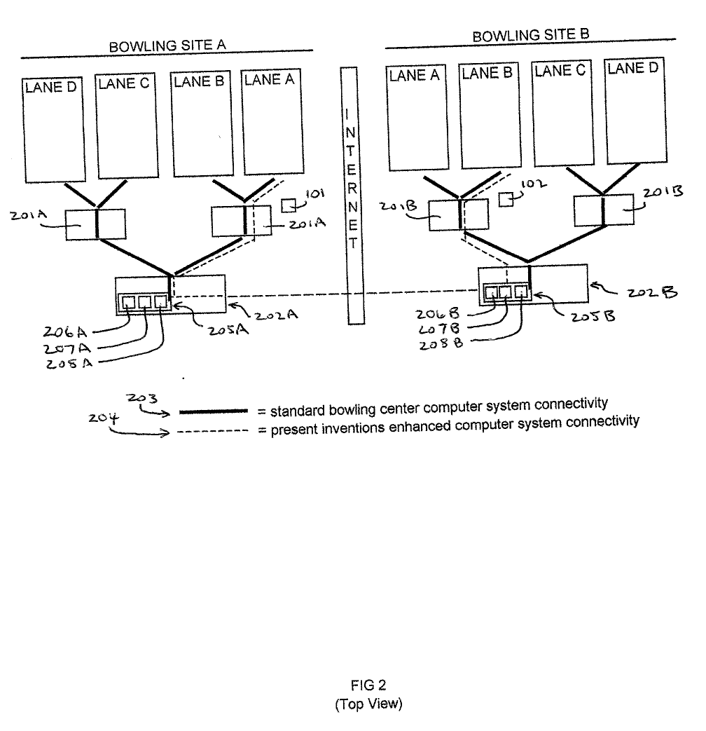

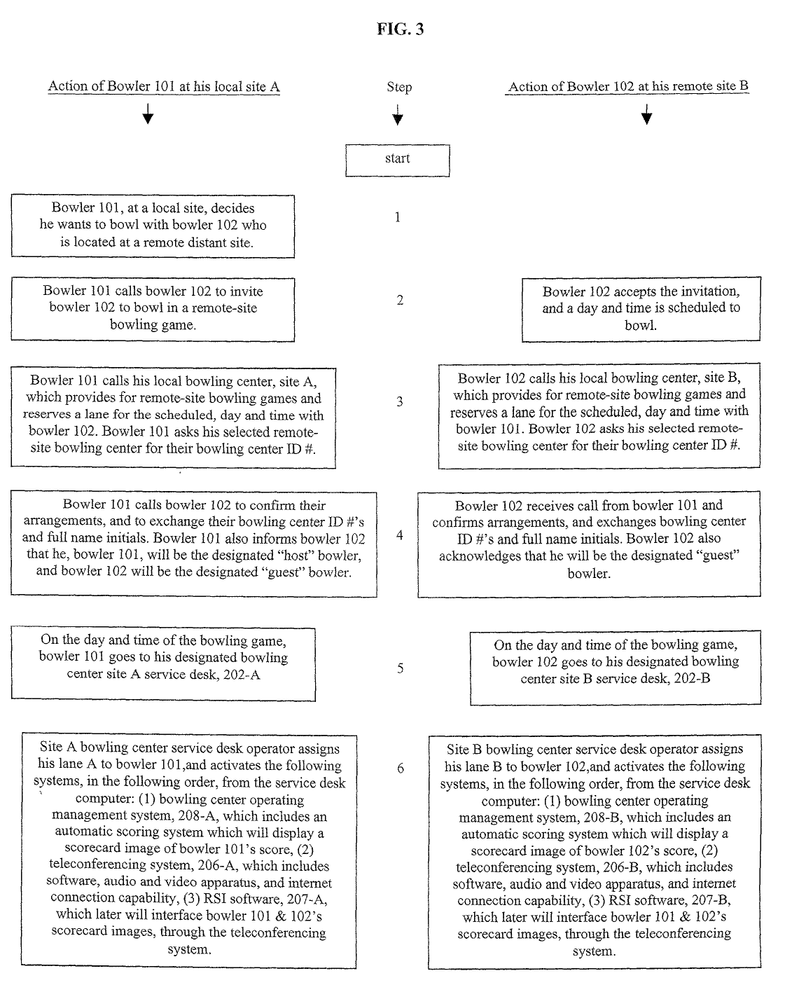

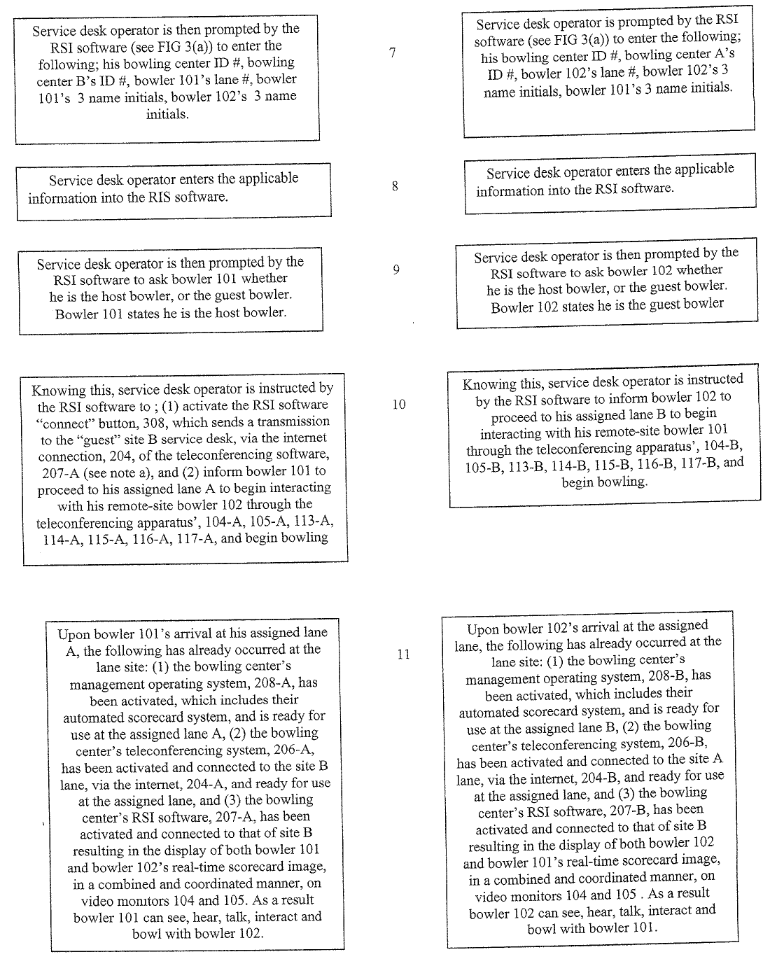

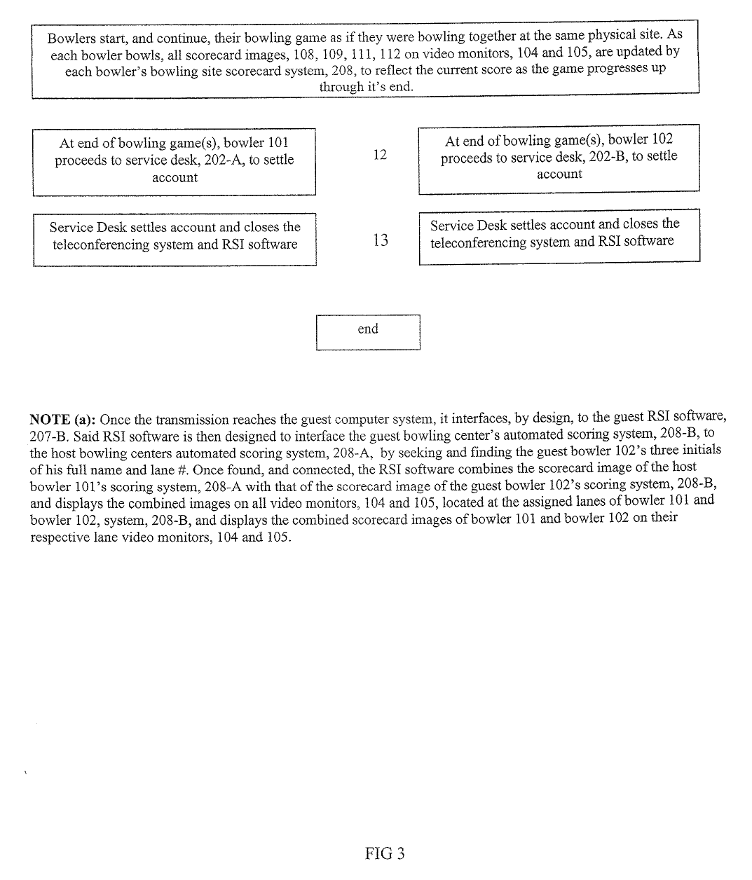

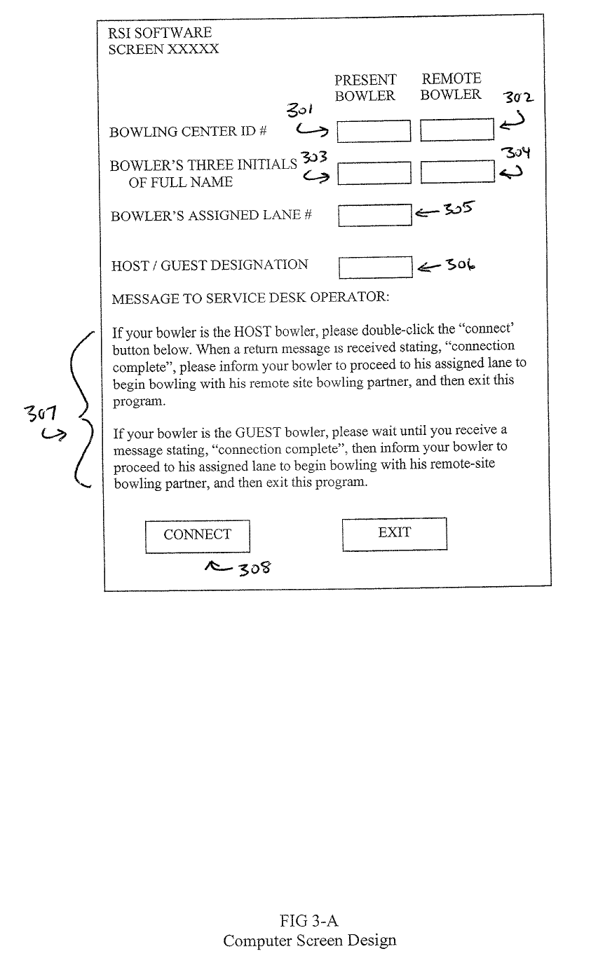

Referring first to FIG. 1, there is shown an overall illustration of a system for bowling remotely arranged in accordance with the present invention. Two bowlers, 101 and 102 are shown, one of which, namely bowler 101, is at lane A of a first or local site A, shown in FIG. 1, and the other bowler, namely bowler 102, is at a physically different, remote, site B, lane B. The system includes teleconferencing capabilities, so that the bowlers at each site can see, hear, talk, interact and exchange data with each other; a bowling center automated management, operating and scoring system at each site; and interface software connecting and combining the automated scoring systems of each bowling site, and instructing the bowling participants through the operation of the remotesite bowling game. In the embodiment of FIG. 1, video images of bowler 101, his bowling lane and lounge area are displayed on video monitors 107-B and 110-B interchangeably as viewed from camera's 113-A and 114-A. Video images of bowler 102, his bowling lane and lounge area are displayed on video monitors 107-A and 110-A, interchangeably, as viewed from camera 113-B and 114-B. Audio of bowler 101 is transmitted through microphone 116-A and heard by bowler 102 at his site B through speaker 115-B. Audio of bowler 102 is transmitted through microphone 116-B and heard by bowler 101 at his site A through speaker 115-A. As an option, each bowler can utilize their wireless microphone/earplug headset 117-A and 117-B in place of the above mentioned microphones, 116-A and 116-B, and speakers 115-A and 115-B. Bowler 101 real-time scorecard images, as created by bowler 101 bowling center scoring system, 208-A (see FIG. 2), are continuously displayed on video monitor section 108-A and 111-A at his site A, and video monitor section 109-B and 112-B at bowler 102 site B. Bowler 102 real-time scorecard images, as created by bowler 102 bowling center scoring system, 208-B, are displayed on video monitor section 108-B and 111-B at his site B, and video monitor section 109-A and 112-A at bowler 101 site A. The scorecard images are able to be transmitted, organized and displayed on all video monitors by the present inventions remote site interface (RSI) software, 207, by connecting the two separate bowling center scoring systems, 208-A and 208-B, through the teleconferencing system. The two bowlers and their respective bowling centers are able to operate the teleconferencing system and scoring systems in coordination with the remote-site bowling game by use of the instructions resident in the present inventions RSI software, 207, which is further described in FIG. 3 and FIG. 3(a).

The arrangement of FIG. 1 is intended to be illustrative of a multimedia communication arrangement, and it is to be understood that other comparable configurations may also be used. For example, the screen size and configuration are not limited, and other video, audio and interface method can be employed. Further, any two or more bowling center's scoring system can be interfaced through the present inventions software. Additionally, the bowling game can be with more than one remote site.

Referring next to FIG. 2, there is shown an overall illustration of two, physically separate, bowling center configurations and their standard system connectivity arranged in accordance with the present inventions enhanced system connectivity. In the embodiment of FIG. 2, two bowling center sites, local site A and remote site B, are shown. The present invention connectivity is made possible by bowling site A and B having separate and independent automated bowling center systems, 208-A and 208-B, which include an automated real-time scoring system that displays a scorecard image on their specific lane's overhead and desk monitors, 104 and 105. The automated bowling center systems, 208-A and 208-B, reside on the bowling center's computer system, 205-A and 205-B, located at the bowling center's service desk, 202-A and 202-B. Each bowling center computer system and automated bowling center system coordinate the bowling game activity by their standard video, audio and data connectivity of 203 in conjunction with the bowlers bowling and knocking over the bowling pins. The present inventions enhanced connectivity, 204, is made possible by bowling site A and site B having teleconferencing software, 206-A and 206-B, and their teleconferencing apparatus'104, 105, 113-117, internet capability and the RSI software, 207-A and 207-B, resident in each sites computer system, 205-A and 205-B. Said RSI software operates in coordination with each sites automated bowling center systems scorecard image, and teleconferencing system.

The arrangement of FIG. 2 is intended to be illustrative of an enhanced system connectivity arrangement, and it is to be understood that other comparable configurations may also be used. For example, instead of connecting the sites by use of the Internet, one could connect with a dedicated telecommunication line from site-to-site.

Referring now to FIG. 3 and 3(a), there is shown a flow chart illustrating the operation of a typical remote-site bowling game in accordance with the present invention. The operation begins when a bowler, in this case, bowler 101, located at a local site A, decides he wants to bowl with bowler 102, who is located at a remote distant site B. Bowler 101 calls bowler 102 to invite bowler 102 to bowl in a remote-site bowling game. Bowler 102 accepts the invitation, and a day and time is scheduled to bowl. Bowler 101 then calls his local bowling center, site A, which provides for remote-site bowling games, and reserves a lane for the scheduled day and time. Bowler 101 also asks his selected remote-site bowling center for their bowling center's ID #. At about the same time, Bowler 102 calls his local bowling center, site B, which provides for remote-site bowling games, and reserves a lane for the scheduled day and time. Bowler 102 also asks his selected remote-site bowling center for bowling center ID #. Bowler 101 then calls bowler 102 to confirm their arrangements, to exchange their bowling center ID #'s, and to exchange the three initials of their fill names. These identifiers will be used later by the present inventions RSI software, 207, to interface the two sites scoring systems, 208-A and 208-B, at the two bowler's lanes. Bowler 101 also informs bowler 102 that he, bowler 101, will be the designated “host” bowler, and bowler 102 will be the designated “guest” bowler. The host and guest designations will be used later by each bowling center service desk operator to activate said RSI software.

On the day and time of the bowling game, bowler 101 goes to his designated local bowling center site A, and bowler 102 goes to his designated local bowling center site B. Each bowler approaches their respective bowling center service desk, 202, acknowledging their reservations for a remote-site bowling game. Each service desk operator assigns a lane to their respective bowler, and activates the following systems, in the following order, for their assigned lanes, from the service desk computer: (1) bowling center operating management system, 208, which includes an automatic scoring system that displays a scorecard image on the lane video monitors, 104 and 105, of the present bowler, (2) teleconferencing system, 206, which includes software, audio and video apparatus, and internet connection capability, (3) RSI software, 207, which later will interface the two bowling center scorecard images, 108,109,111 and 112, through the teleconferencing system, and displays the scorecard images in an organized, combined and coordinated manner on the video lane monitors, 104 and 105, at bowler 101 and bowler 102's assigned lanes.

After the RSI software, 207, is activated, each service desk operator is prompted by the RSI software (see FIG. 3(a)) to enter the following; their bowling center ID #, 301, the remote bowler's bowling center ID #, 302, the present bowler's three initials of his full name, 303, the remote bowler's three initials of his full name, 304, and the present bowler's lane #, 305. Each service desk operator enters this identifying information into the RSI software, 207, as instructed by the RSI software through their service desk computer system, 205. Each service desk operator is then prompted by the RSI software instruction, 306, to ask their respective bowler whether he is the host bowler, or the guest bowler. Bowler 101, at site A, states he is the host bowler. Bowler 102, at site B, states he is the guest bowler. Knowing this, the service desk operator of the host bowler 101 is instructed by the RSI software instruction, 307, to activate the RSI software “connect” button, 308, which sends a transmission to the guest bowler 102's service desk computer, via the internet connection, 204, of the teleconferencing software, 206. Once the transmission reaches the guest computer system, it interfaces, by design, to the guest RSI software, 207-B. Said RSI software is then designed to interface the guest bowling center's automated scoring system, 208-B, to the host bowling centers automated scoring system, 208-A, by seeking and finding the guest bowler 102's three initials of his full name and lane #. Once found, and connected, the RSI software combines the scorecard image of the host bowler 101's scoring system, 208-A, with that of the scorecard image of the guest bowler 102's scoring system, 208-B, and displays the combined images on all video monitors, 104 and 105, located at the assigned lanes of bowler 101 and bowler 102. Once the “connect” button, 308, is activated and the connection is made, the service desk operator of bowler 101 instructs bowler 101 to proceed to his assigned lane A to begin interacting with his remote-site bowler 102 through the teleconferencing apparatus', 104-A, 105-A, 113-A, 114-A, 115-A, 116-A, and 117-A, and begin bowling. Knowing that bowler 102 is the guest bowler, his respective service desk operator is instructed by the RSI software, 307, to inform bowler 102 to proceed to his assigned lane B, after viewing a “connection complete” RSI software message, to begin interacting with his remote bowler 101 through the teleconferencing apparatus', 104-B, 105-B, 113-B, 114-B, 115-B, 116-B, and 117-B, and begin bowling.

Upon arrival to their respective assigned lanes of bowler 101 and bowler 102, the following has already occurred at each lane: (1) each bowling center's management operating system, 208, has been activated, which includes their automated scorecard system, and is ready for use at the assigned lanes, (2) each bowling center's teleconferencing system, 206, has been activated and connected to the remote site lane, via the internet, 204, and ready for use at the assigned lanes, and (3) each bowling center's RSI software, 207, has been activated and connected to each other resulting in the displaying of both bowler 101 and bowler 102's real-time scorecard images, 108, 109, 111 and 112, in an organized, combined and coordinated manner, on all video lane monitors located at each lane site, 104 and 105. As a result, bowler 101 can see, hear, talk, interact and bowl with bowler 102, and bowler 102 can see, hear, talk, interact and bowl with bowler 101.

The bowlers then start, and continue, their bowling game as if they were bowling together at the same physical site. As each bowler takes their turn to bowl, all scorecard images, 108, 109, 111 and 112, on video monitors, 104 and 105, are updated by each bowler's bowling site scoring system, 208, to reflect the current score as the game progresses. At the end of the bowling game, bowler 101 and bowler 102 proceed to their respective service desks, 202, to settle their accounts. Each service desk then de-activates all systems previously activated.

The arrangements of FIG. 3 and FIG. 3(a) are intended to be illustrative of a remote-site bowling game operation, and it is to be understood that other comparable configurations may also be used. For example, there can be more than one remote-bowling site participating in a remote-site bowling game. Also, bowling center reservations are not necessarily required. Other identifiers can be used in place of the above mentioned identifiers. Further, the bowling images transmitted through the teleconferencing system can also be shared with third party viewers, via the Internet.

Various modifications and adaptations within the spirit of the invention will be apparent to those persons skilled in the art. For example, the video screen sizes and configurations are not limited, other video, audio and interface methods can be employed, and other multimedia type systems can be employed. Additionally, the bowling game can be with more than one remote site. Also, instead of connecting the sites by use of the Internet, one could connect with a dedicated telecommunication line from site-to-site. Other identifiers can be used in place of the above mentioned identifiers. Further, the bowling images transmitted through the teleconferencing system can also be shared with third party viewers, via the Internet. Accordingly, the invention should only be limited by the following claims.

I claim:

1. A system for bowling with remote bowlers including: a multimedia communications system including audio, video and data communication means and arranged so that bowlers at a plurality of bowling sites can see, hear, talk and exchange data with each other, and
a bowling scoring system including a computer system with hardware and software means and arranged so that each bowler's score is calculated and displayed as a scorecard image on a video monitor at their bowling site and continually updates said scorecard image as said bowlers bowling game progresses,
means to combine said scorecard images of said bowling scoring systems, through said multimedia communications systems, and display said combined scorecard images onto the UNIX video means of said multimedia communication systems at said sites.

2. A method for bowling with remote bowlers including the steps of:
activating a multimedia communication system at each bowling site, including audio, video and data communications means for seeing, hearing, talking and exchanging data with each other,
activating a bowling scoring system at said sites, including a computer system with hardware and software means arranged so that each bowler's score is calculated and displayed as a scorecard image on a video monitor at their bowling site and continually updates said scorecard image as said bowlers bowling game progresses,
activating a computer program with interface means of said bowling scoring systems, through said multimedia communication systems,
means wherein said multimedia communication systems, said bowling scoring systems, and said computer program are arranged so that, when activated, bowlers at said plurality of bowling sites can see, hear, talk and exchange bowling scores with each other.

3. The method defined in claim 2 wherein said interface means of said bowling scoring systems include means for bowler scorecard images, of said bowling scoring systems, to be displayed in a combined, organized and coordinated manner on the video means of said multimedia communication systems, at said bowling sites.

4. The method defined in claim 3 wherein said scorecard images are continually updated by said bowling scoring systems as their bowling game progresses and are displayed onto the video means of said multimedia communication systems at said sites.

5. The method defined in claim 4 wherein said computer program includes a computer screen design means arranged so that said bowling sites can interface said scorecard images in a combined and organized manner and display said scorecard images on the video means of said multimedia communication system at said bowling sites.

6. The method defined in claim 5 wherein said computer screen design includes the steps of:
displaying information which will prompt said bowling site computer operators to request from their respective bowlers unique identifiers;
instruct said computer operators to enter said unique identifiers;
instruct said computer operators to interface the scorecard images of said bowlers at said bowling sites resulting in the display of said scorecard images, in a combined manner, on the video means of said multimedia communication system at said bowling sites.

7. A computer program with means for interfacing one bowling sites scoring system to remote site bowling scoring systems comprising:
a computer screen design means for displaying information identifying participating bowlers and said bowling sites;
identifiers that specifically identify said bowlers, said bowling sites, and said bowler's bowling lanes at said bowling sites participating in a remote-site bowling game;
an action connecting means that in response to performance of action by one bowling site, sends a transmission through a multimedia communications system to each remote bowling site which interfaces the bowling scoring systems of both sites;
an action that in response to said interface organizes, combines and coordinates the scorecard images as one scorecard image of said bowlers at said bowling sites and displays said one scorecard image of said bowlers on the video means of said multimedia communication systems at said bowling sites.
